(19) United States
(12) Patent Application Publication
(10) Pub. No.: US 2025/0328359 A1
(43) Pub. Date: Oct. 23, 2025

(54) REDUCING DEVICE IMAGE SIZE BY MODULARIZING GRAPHICAL USER INTERFACE CONTENT

(71) Applicant: DELL PRODUCTS L.P., Round Rock, TX (US)

(72) Inventors: Farhan Syed, Bangalore (IN); Vinod Subrahmanya, Hootagalli (IN); AVS SashiKiran, Bengaluru (IN)

(73) Assignee: DELL PRODUCTS L.P., Round Rock, TX (US)

(21) Appl. No.: 18/638,843

(22) Filed: Apr. 18, 2024

(51) Int. Cl. G06F 9/451

(52) U.S. Cl. CPC G06F 9/451

(57) ABSTRACT

Techniques for reducing the size of computing device images are described. One example method includes identifying an image to be used to configure the computing device, wherein the image includes software programs and configuration information for use by the computing device during operation; configuring the computing device according to the identified image; identifying a request for a graphical user interface (GUI) resource; retrieving static GUI configuration information associated with the GUI resource from a remote server over a network; and displaying a visual representation of the GUI resource on a display device, wherein the visual representation of the GUI resource is based at least in part on the static GUI configuration information.

### TECHNICAL FIELD

The present disclosure relates in general to information handling systems, and more particularly to techniques for reducing device image size by modularizing graphical user interface (GUI) content in information handling systems.

### BACKGROUND OF THE INVENTION

A device image (also referred to as a “disk image,” or as simply an “image”) is a representation of data stored in a particular storage device, such as a hard drive or a flash memory device, and generally includes software programs and associated data for use by a computing device containing the particular storage device. For example, an image of a particular storage device may be created and stored in a different location as a backup copy, and may be used to restore the particular storage device or a different storage to the state represented by the backup copy (e.g., in the event of hardware failure). Images may also be used to quickly initialize one or more computing devices to a standard configuration represented by the image, such as a configuration including a standard set of software programs. In some cases, an image may represent a bit-level representation of the desired state of the storage device, and may include, for example, an initial file system structure, an operating system, software programs, software libraries, drivers, configuration or other data, and the like. In some implementations, an image may be compressed to reduce its data size (e.g., for transfer over a network), and subsequently decompressed by the computing device prior to using the image to initialize a storage device.

### SUMMARY OF THE INVENTION

In accordance with embodiments of the present disclosure, a method for reducing the size of computing device images includes identifying an image to be used to configure the computing, wherein the image includes software programs and configuration information for use by the computing device during operation; configuring the computing device according to the identified image; after configuring the computing device according to the identified image, identifying a request for a graphical user interface (GUI) resource; retrieving static GUI configuration information associated with the GUI resource from a remote server over a network; and in response to response to retrieving the static GUI configuration information, displaying a visual representation of the GUI resource on a display device, wherein the visual representation of the GUI resource is based at least in part on the static GUI configuration information.

In some cases, the image does not include the static GUI configuration information.

In some implementations, the static GUI configuration information includes at least one of Javascript data, Hypertext Markup Language (HTML) data, or Cascading Style Sheets (CSS) data.

In some cases, the static GUI configuration information is packaged in a modularized application format.

In some implementations, the request is a first request, the static GUI configuration information is a first static GUI configuration information, the visual representation is a first visual representation, and the method includes identifying a second request for the GUI resource; retrieving second static GUI configuration information associated with the GUI resource from the remote server, wherein the second static GUI configuration information is different than the first static GUI configuration information; and in response to response to retrieving the second static GUI configuration information, displaying a second visual representation of the GUI resource on the display device, wherein the second visual representation of the GUI resource is based at least in part on the second static GUI configuration information, and wherein the second visual representation is different than the first visual representation.

In some implementations, the first static GUI configuration information is associated with a first language, and the second static GUI configuration information is associated with a second than the first language.

In some cases, the request is a first request, the static GUI configuration information is a first static GUI configuration information, the GUI resource is a first GUI resource, and the method includes identifying a second request for a second GUI resource different than the first GUI resource; and retrieving second static GUI configuration information associated with the second GUI resource from the remote server, wherein the second static GUI configuration information is different than the first static GUI configuration information.

In accordance with embodiments of the present disclosure, a system for reducing the size of computing device images includes a computer system including at least one processor and a memory, and configured to perform operations including identifying an image to be used to configure the computing, wherein the image includes software programs and configuration information for use by the computing device during operation; configuring the computing device according to the identified image; after configuring the computing device according to the identified image, identifying a request for a graphical user interface (GUI) resource; retrieving static GUI configuration information associated with the GUI resource from a remote server over a network; and in response to response to retrieving the static GUI configuration information, displaying a visual representation of the GUI resource on a display device, wherein the visual representation of the GUI resource is based at least in part on the static GUI configuration information.

In accordance with embodiments of the present disclosure, an article of manufacture includes a non-transitory, computer-readable medium having computer-executable instructions thereon that are executable by a processor of a computer system to perform operations for reducing the size of computing device images including identifying an image to be used to configure the computing, wherein the image includes software programs and configuration information for use by the computing device during operation; configuring the computing device according to the identified image; after configuring the computing device according to the identified image, identifying a request for a graphical user interface (GUI) resource; retrieving static GUI configuration information associated with the GUI resource from a remote server over a network; and in response to response to retrieving the static GUI configuration information, displaying a visual representation of the GUI resource on a display device, wherein the visual representation of the GUI resource is based at least in part on the static GUI configuration information.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE SEVERAL VIEWS OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates a block diagram of example components of a system for reducing device image size by modularizing GUI content, in accordance with embodiments of the present disclosure;

FIG. 3 illustrates a flow chart of an example process for reducing device image size by modularizing GUI content, in accordance with embodiments of the present disclosure.

### DETAILED DESCRIPTION OF THE INVENTION

The present disclosure describes techniques for reducing device image size by modularizing GUI content in information handling systems.

As described above, a disk image may be used to initialize computing devices to a standard configuration. As more data is included in the image, such as additional software programs or additional features to existing programs, the data size of the image increases. Because the image generally is transmitted over a network and then processed by a receiving computing device before being applied, an increase in the size of the image generally leads to a corresponding increase in the time needed to initialize the computing device based on the image. Such delays can be problematic, for example, because the computing device is generally unavailable during this initialization process. Thus, reducing the size of disk images may lead to a faster and more efficient initialization and/or recovery process, and may lead to higher availability and less downtime of the affected computing devices.

The present disclosure describes techniques for reducing image size by modularizing static GUI content (such as text, images, etc.), thereby allowing this content to be omitted from the image and instead retrieved by the computing device at run-time (e.g., when a particular GUI resource utilizing the static GUI content is used). In some cases, the static GUI content may be modularized into multiple packages, and may be downloaded by the computing device from a remote server over a network at run-time. Omitting this static content from the image reduces the data size of the image. These techniques may also enable greater flexibility and efficiency, as changes to the static GUI content may be made on the remote server, allowing them to take effect the next time the computing device requests the static GUI content. Further, because the remote server may provide the same static GUI content to multiple computing devices, it may not be necessary to apply an update to each computing device in order to affect a change to the static GUI content, as each device will receive the updated static GUI content in response to its next request for it.

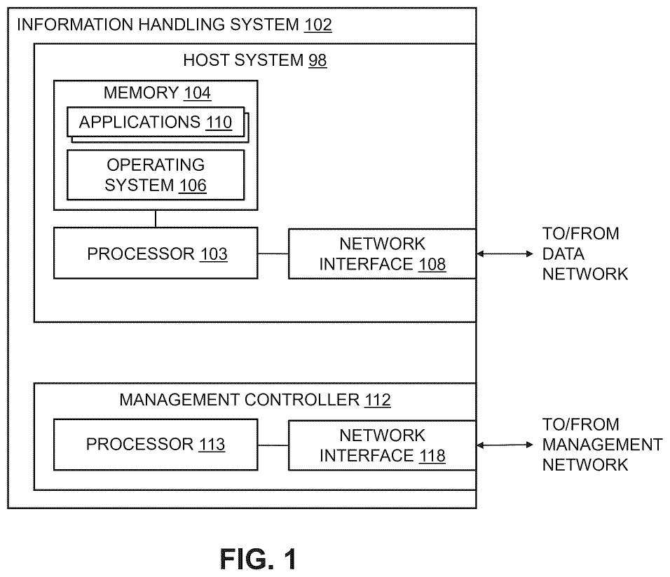

Preferred embodiments and their advantages are best understood by reference to FIGS. 1 through 3, wherein like numbers are used to indicate like and corresponding parts.

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and management a controller 112 communicatively coupled to processor 103 (e.g., via a management network).

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may storage media to memory 104 for be transferred from such execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

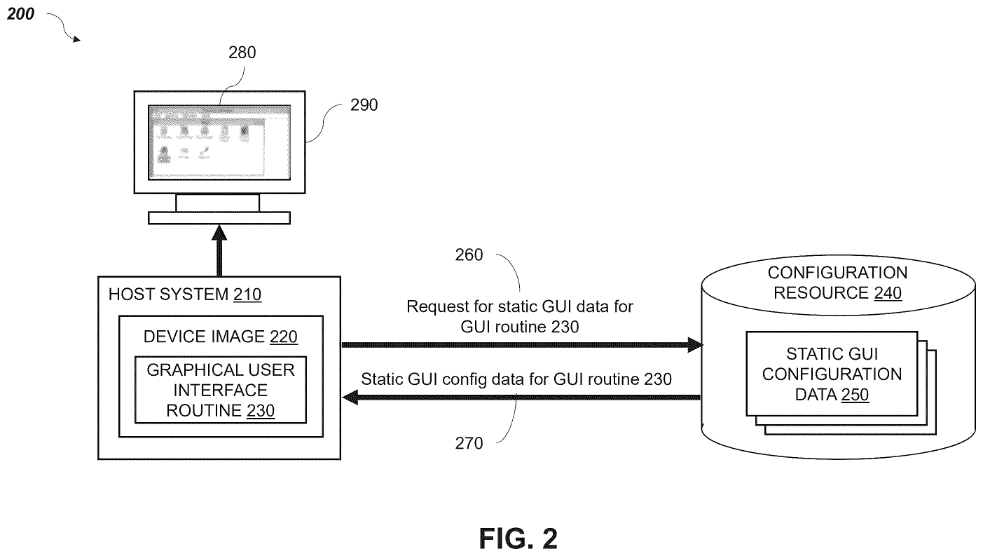

FIG. 2 illustrates a block diagram of example components of a system 200 for reducing device image size by modularizing GUI content, in accordance with embodiments of the present disclosure. As shown, the system 200 includes host device 210 communicatively coupled to a configuration resource 240 by a communications network (not shown). In some cases, the host device 210 may be configured like the host device 98 of FIG. 1.

The host system 210 includes a device image 220. In some cases, the device image 220 may have been used to initialize a storage device of the host system 210 (e.g., memory 104 in FIG. 1) and may include the operating system 106 and applications 110. Note that FIG. 2 represents host system 210 at a time after its storage device has been initialized to the state represented by the device image 220, and thus the state of the storage device may changed from this initial state during operation of the host system 210.

As shown, the device image 220 includes a GUI routine 230. In some cases, GUI routine 230 may include software instructions that will cause a particular GUI resource (such as a particular screen or window) to be displayed upon execution. The GUI routine 230 may be invoked in response to a request for the associated GUI resource, such as by an application being executed by the host system 210. In some cases, the request may be a call to a function within a software library associated with the GUI routine 230 that occurs during execution of the application.

Configuration resource 240 is a storage location remote from the host system 210 that stores static GUI configuration data 250 (discussed below). In some cases, configuration resource 240 may a server that stores the static GUI configuration data 250 in a database. In some implementations, configuration resource 240 may be a distributed network of multiple servers that provide static GUI configuration data 250 to a plurality of host systems. In some cases, the configuration resource 240 stores the static GUI configuration data 250 in association with identifiers of associated graphical user interface routines 230, thereby enabling it to provide a particular static GUI configuration data 250 associated with a particular GUI routine 230 in response to a request from the host system 210 (as discussed below).

In operation, host system 210 sends a request 260 for static GUI configuration data associated with GUI routine 230 to the configuration resource 240. In some cases, the host system 210 sends the request 260 in response to the GUI routine 230 being invoked as described above. In response, the configuration resource 240 sends particular static GUI configuration data 250 associated with the GUI routine 230. In some cases, the request 260 may include a language or locale identifier, and the configuration resource 240 may respond with the appropriate static GUI configuration data 250 for that language or locale. The request 260 and response 270 may be formatted according to any suitable network format, such as, for example, Hypertext Transfer Protocol (HTTP), or another suitable format.

Static GUI configuration data 250 may include front-end static files used to create a visual representation 280 of the GUI resource (e.g., a screen, a window, etc.) for display on a display device 290 associated with the host system 210. Although shown as a standard computer monitor in FIG. 2, in some cases, the display device 290 may be an integrated display of the host system 210 or a remote display controlled by host system 210 over a network. The static GUI configuration data 250 may include static content used to create the visual representation 280, such as, for example, text, icons, images, and the like. In some implementations, a particular static GUI configuration data 250 may be associated with a particular language or locale in addition to the particular GUI resource. In such a case, the particular GUI resource may be associated with multiple items of static GUI configuration data 250, such as one associated with each language or locale supported by the particular GUI resource.

In some cases, the static GUI configuration data 250 may include a set of static files for use in creating the visual representation 280. The files may be in one or more suitable formats, such as Javascript, Hypertext Markup Language (HTML), Cascading Style Sheets (CSS), and the like.

In some implementations, each static GUI configuration data 250 may be packaged separately in a lightweight application format that will allow it to be easily installed by the host system 210 after retrieval from the configuration resource 240. The lightweight application format may be, for example, FLATPAK, DPKG, RPM, PACMAN, or any suitable format.

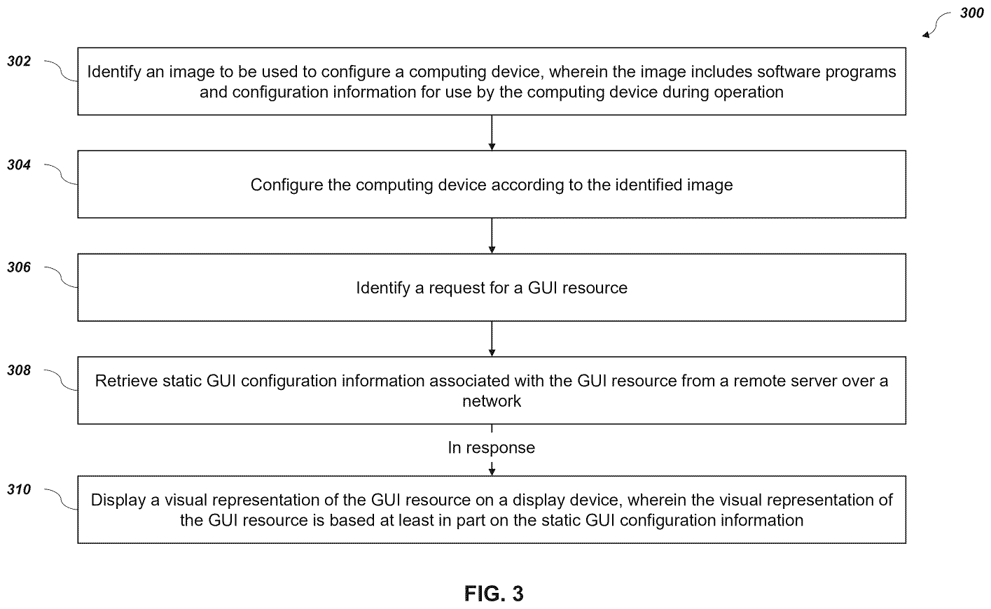

FIG. 3 illustrates a flow chart of an example process 300 for reducing device image size by modularizing GUI content, in accordance with embodiments of the present disclosure. In some implementations, the process 300 may be performed in the context of the systems of FIGS. 1 and 2.

As shown, at 302, an image to be used to configure a computing device is identified, wherein the image includes software programs and configuration information for use by the computing device during operation.

At 304, the computing device is configured according to the identified image.

At 306, after configuring the computing device according to the identified image, a request for a graphical user interface (GUI) resource is identified.

At 308, static configuration information GUI associated with the GUI resource is retrieved from a remote server over a network.

At 310, in response to response to retrieving the static GUI configuration information, a visual representation of the GUI resource is displayed on a display device, wherein the visual representation of the GUI resource is based at least in part on the static GUI configuration information.

In some implementations, the image does not include the static GUI configuration information.

In some cases, the static GUI configuration information includes at least one of Javascript data, Hypertext Markup Language (HTML) data, or Cascading Style Sheets (CSS) data.

In some implementations, the static GUI configuration information is packaged in a modularized application format.

In some cases, the request is a first request, the static GUI configuration information is a first static GUI configuration information, the visual representation is a first visual representation, and the process includes identifying a second request for the GUI resource; retrieving second static GUI configuration information associated with the GUI resource from the remote server, wherein the second static GUI configuration information is different than the first static GUI configuration information; and in response to response to retrieving the second static GUI configuration information, displaying a second visual representation of the GUI resource on the display device, wherein the second visual representation of the GUI resource is based at least in part on the second static GUI configuration information, and wherein the second visual representation is different than the first visual representation.

In some implementations, the first static GUI configuration information is associated with a first language, and the second static GUI configuration information is associated with a second language different than the first language.

In some cases, the request is a first request, the static GUI configuration information is a first static GUI configuration information, the GUI resource is a first GUI resource, and the process 300 includes identifying a second request for a second GUI resource different than the first GUI resource; and retrieving second static GUI configuration information associated with the second GUI resource from the remote server, wherein the second static GUI configuration information is different than the first static GUI configuration information.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112 (f) for that claim element. Accordingly, none of the claims in this application as filed are intended to be interpreted as having means-plus-function elements. Should Applicant wish to invoke § 112 (f) during prosecution, Applicant will recite claim elements using the “means for [performing a function]” construct.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system provides management functionality that (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. A method for reducing the size of computing device images, the method comprising:
identifying, by a computing device, an image to be used to configure the computing device, wherein the image includes software programs and configuration information for use by the computing device during operation;
configuring, by the computing device, the computing device according to the identified image;
after configuring the computing device according to the identified image, identifying, by the computing device, a request for a graphical user interface (GUI) resource;
retrieving, by the computing device, static GUI configuration information associated with the GUI resource from a remote server over a network; and
in response to response to retrieving the static GUI configuration information, displaying, by the computing device, a visual representation of the GUI resource on a display device, wherein the visual representation of the GUI resource is based at least in part on the static GUI configuration information.

2. The method of claim 1, wherein the image does not include the static GUI configuration information.

3. The method of claim 1, wherein static GUI configuration information includes at least one of Javascript data, Hypertext Markup Language (HTML) data, or Cascading Style Sheets (CSS) data.

4. The method of claim 1, wherein the static GUI configuration information is packaged in a modularized application format.

5. The method of claim 1, wherein the request is a first request, the static GUI configuration information is a first static GUI configuration information, the visual representation is a first visual representation, and the method further comprising:
identifying, by the computing device, a second request for the GUI resource;
retrieving, by the computing device, second static GUI configuration information associated with the GUI resource from the remote server, wherein the second static GUI configuration information is different than the first static GUI configuration information; and
in response to response to retrieving the second static GUI configuration information, displaying, by the computing device, a second visual representation of the GUI resource on the display device, wherein the second visual representation of the GUI resource is based at least in part on the second static GUI configuration information, and wherein the second visual representation is different than the first visual representation.

6. The method of claim 1, wherein the first static GUI configuration information is associated with a first language, and the second static GUI configuration information is associated with a second language different than the first language.

7. The method of claim 1, wherein the request is a first request, the static GUI configuration information is a first static GUI configuration information, the GUI resource is a first GUI resource, and the method further comprising:
identifying, by the computing device, a second request for a second GUI resource different than the first GUI resource; and
retrieving, by the computing device, second static GUI configuration information associated with the second GUI resource from the remote server, wherein the second static GUI configuration information is different than the first static GUI configuration information.

8. A system for reducing the size of computing device images comprising:
a computer system including at least one processor and a memory, and configured to perform operations including:
identifying an image to be used to configure the computing device, wherein the image includes software programs and configuration information for use by the computing device during operation;
configuring the computing device according to the identified image;
after configuring the computing device according to the identified image, identifying a request for a graphical user interface (GUI) resource;
retrieving static GUI configuration information associated with the GUI resource from a remote server over a network; and
in response to response to retrieving the static GUI configuration information, displaying a visual representation of the GUI resource on a display device, wherein the visual representation of the GUI resource is based at least in part on the static GUI configuration information.

9. The system of claim 8, wherein the image does not include the static GUI configuration information.

10. The system of claim 8, wherein static GUI configuration information includes at least one of Javascript data, Hypertext Markup Language (HTML) data, or Cascading Style Sheets (CSS) data.

11. The system of claim 8, wherein the static GUI configuration information is packaged in a modularized application format.

12. The system of claim 8, wherein the request is a first request, the static GUI configuration information is a first static GUI configuration information, the visual representation is a first visual representation, and the operations further comprising:
identifying a second request for the GUI resource;
retrieving second static GUI configuration information associated with the GUI resource from the remote server, wherein the second static GUI configuration information is different than the first static GUI configuration information; and
in response to response to retrieving the second static GUI configuration information, displaying a second visual representation of the GUI resource on the display device, wherein the second visual representation of the GUI resource is based at least in part on the second static GUI configuration information, and wherein the second visual representation is different than the first visual representation.

13. The system of claim 8, wherein the first static GUI configuration information is associated with a first language, and the second static GUI configuration information is associated with a second language different than the first language.

14. The system of claim 8, wherein the request is a first request, the static GUI configuration information is a first static GUI configuration information, the GUI resource is a first GUI resource, and the operations further comprising:
identifying a second request for a second GUI resource different than the first GUI resource; and
retrieving second static GUI configuration information associated with the second GUI resource from the remote server, wherein the second static GUI configuration information is different than the first static GUI configuration information.

15. An article of manufacture comprising a non-transitory, computer-readable medium having computer-executable instructions thereon that are executable by a processor of a computer system to perform operations for reducing the size of computing device images, the operations comprising:
identifying an image to be used to configure the computing device, wherein the image includes software programs and configuration information for use by the computing device during operation;
configuring the computing device according to the identified image;
after configuring the computing device according to the identified image, identifying a request for a graphical user interface (GUI) resource;
retrieving static GUI configuration information associated with the GUI resource from a remote server over a network; and
in response to response to retrieving the static GUI configuration information, displaying a visual representation of the GUI resource on a display device, wherein the visual representation of the GUI resource is based at least in part on the static GUI configuration information.

16. The article of claim 15, wherein the image does not include the static GUI configuration information.

17. The article of claim 15, wherein static GUI configuration information includes at least one of Javascript data, Hypertext Markup Language (HTML) data, or Cascading Style Sheets (CSS) data.

18. The article of claim 15, wherein the static GUI configuration information is packaged in a modularized application format.

19. The article of claim 15, wherein the request is a first request, the static GUI configuration information is a first static GUI configuration information, the visual representation is a first visual representation, and the operations further comprising:
identifying a second request for the GUI resource;
retrieving second static GUI configuration information associated with the GUI resource from the remote server, wherein the second static GUI configuration information is different than the first static GUI configuration information; and
in response to response to retrieving the second static GUI configuration information, displaying a second visual representation of the GUI resource on the display device, wherein the second visual representation of the GUI resource is based at least in part on the second static GUI configuration information, and wherein the second visual representation is different than the first visual representation.

20. The article of claim 15, wherein the first static GUI configuration information is associated with a first language, and the second static GUI configuration information is associated with a second language different than the first language.
